(19) United States
(12) Patent Application Publication
(10) Pub. No.: US 2019/0013026 A1
(43) Pub. Date: Jan. 10, 2019

(54) SYSTEM AND METHOD FOR EFFICIENT LIVENESS DETECTION

(71) Applicant: Alibaba Group Holding Limited, George Town (KY)

(72) Inventors: Xuetao Feng, Beijing (CN); Yan Wang, Beijing (CN)

(73) Assignee: Alibaba Group Holding Limited, George Town (KY)

(21) Appl. No.: 16/019,955

(22) Filed: Jun. 27, 2018

(30) Foreign Application Priority Data
Jul. 5, 2017 (CN) 201710542605.7

(51) Int. Cl. G10L 17/22; G10L 17/00; G10L 17/02; G10L 25/84

(52) U.S. Cl. CPC G10L 17/22; G10L 25/84; G10L 17/02; G10L 17/005

(57) ABSTRACT

Embodiments described herein provide a system for facilitating liveness detection of a user. During operation, the system presents a verification interface to the user in a local display device. The verification interface includes one or more phrases and a reading style for a respective phrase in which the user is expected to recite the phrase. The system then obtains a voice signal based on the user's recitation of the one or more phrases via a voice input device of the system and determines whether the user's recitation of a respective phrase has complied with the corresponding reading style. If the user's recitation of a respective phrase has complied with the corresponding reading style, the system establishes liveness for the user.

### RELATED APPLICATION

Under 35 U.S.C. § 119, this application claims the benefit and right of priority of Chinese Patent Application No. 201710542605.7, filed 5 Jul. 2017.

### BACKGROUND

### Field

This disclosure is generally related to the field of identity authentication. More specifically, this disclosure is related to a system and method for automated liveness detection of an authenticating user.

### Related Art

The proliferation of the Internet and e-commerce continues to motivate users to create a vast digital presence. However, a user's digital presence can be vulnerable to attacks (e.g., ransomware and hacking) from malicious users. As a result, users have become more and more concerned about network security. Traditionally, a user's online presence associated with a particular service (e.g., an email account) is protected based on a “username and password,” a key, an intelligent card and/or an identity card. However, these methods are subject to a number of issues, such as loss, theft, and duplication. Furthermore, these traditional identity authentication methods may fail to distinguish real humans from bots and, therefore, may fail to address some security concerns of the user.

To improve identity authentication of a user, authentication systems can be based on biological feature identification. Due to the uniqueness and stability of the biological features of a human, the biological features have been extensively used in various application systems where identity authentication is required. For example, payment functions and remote account opening in financial and/or shopping applications on user devices may incorporate biological feature identification to ensure that the user providing the authenticating credentials is a real human.

Examples of commonly used biological feature identification include facial recognition, fingerprint recognition, iris recognition, voiceprint recognition, etc. While the identity authentication system based on the biological feature identification improves the efficiency of the authentication process and provides convenience to a user, counterfeiting of the biological feature identification still remains a concern. To further bolster the authentication process, liveness detection technology can be used to verify the authenticity of the user. Liveness detection allows a system to ensure that the person authenticating is a real human.

While liveness detection brings many desirable features to the authentication process, some issues remain unsolved in mitigating the spoofing od human presence.

### SUMMARY

Embodiments described herein provide a system for facilitating liveness detection of a user. During operation, the system presents a verification interface to the user in a local display device. The verification interface includes one or more phrases and a reading style for a respective phrase in which the user is expected to recite the one or more phrases. The system then obtains a voice signal based on the user's recitation of the one or more phrases via a voice input device of the system and determines whether the user's recitation of a respective phrase has complied with the corresponding reading style. If the user's recitation of a respective phrase has complied with the corresponding reading style, the system establishes liveness for the user.

In a variation on this embodiment, the system provides a read-out of a respective phrase of the one or more phrases in a corresponding reading style as a guideline to the user.

In a variation on this embodiment, the system determines whether the user has recited a respective phrase of the one or more phrases correctly. Establishing liveness for the user is then further dependent upon determining that the user has recited a respective phrase of the one or more phrases correctly.

In a variation on this embodiment, the system obtains a video signal corresponding to the voice signal via a voice input device of the system. The system then determines mouth movements of the user from the video signal and determines whether the mouth movements are consistent with the user's recitation of a respective phrase in the corresponding reading style. Establishing liveness for the user is then further dependent upon determining that the mouth movements are consistent.

In a variation on this embodiment, determining whether the user's recitation of a respective phrase has complied with the corresponding reading style includes: (i) pre-processing the voice signal to eliminate noise, and (ii) generating one or more voice segments from the voice signal.

In a further variation, the system extracts features from a respective voice segment, determines features associated with a respective phrase of a respective voice segment, and categorizes the determined features.

In a variation on this embodiment, the reading style for a respective phrase is indicated based on one or more display features. The display features can include one or more of: appearance, position, dimension, color, and font of the phrase.

In a further variation, the system displays the one or more phrases in the verification interface in accordance with the display features and specifies what the display features indicate.

In a variation on this embodiment, the system determines the one or more phrases prior to presenting the verification interface to the user. The system can determine the one or more phrases based on one or more of: obtaining a phrase from a repository of phrases, obtaining a phrase from the Internet, and reshuffling words and/or characters of a phrase.

In a variation on this embodiment, a respective phrase of the one or more phrases includes one or more of: a meaningful phrase, a set of related or unrelated words, one or more characters, one or more numbers, one or more symbols, and one or more patterns.

### BRIEF DESCRIPTION OF THE FIGURES

FIG. 1A illustrates an exemplary uncertainty-based liveness detection system, in accordance with an embodiment of the present application.

FIG. 1B illustrates an exemplary verification interface that facilitates uncertainty-based liveness detection, in accordance with an embodiment of the present application.

FIG. 2 illustrates an exemplary mouth action detection of a liveness detection system, in accordance with an embodiment of the present application.

FIG. 3 illustrates an exemplary liveness detection system using audio-visual uncertainty, in accordance with an embodiment of the present application.

FIG. 4 presents a flowchart illustrating a method of a liveness detection system determining liveness of an authenticating user, in accordance with an embodiment of the present application.

FIG. 5A presents a flowchart illustrating a method of a liveness detection system determining a reading style for liveness detection, in accordance with an embodiment of the present application.

FIG. 5B presents a flowchart illustrating a method of a liveness detection system determining facial features corresponding to a voice signal for liveness detection, in accordance with an embodiment of the present application

FIG. 6 illustrates an exemplary computer system that facilitates an uncertainty-based liveness detection system, in accordance with an embodiment of the present application.

FIG. 7 illustrates an exemplary apparatus that facilitates an uncertainty-based liveness detection system, in accordance with an embodiment of the present application.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

### Overview

The embodiments described herein solve the problem of spoofing a liveness detection system by using uncertainty in detecting the presence of a human. Liveness detection refers to the process of determining whether a user is complying with certain instructions. For example, a system may provide instructions for one or more actions (e.g., blinking or gesturing) and the user can perform the corresponding actions.

With existing technologies, when a user attempts to authenticate himself/herself to gain access to a service, a liveness detection system may use facial recognition, voiceprint recognition, or both to determine whether a human is performing the authentication. Typically, the system pre-acquires visual data (e.g., a video of certain actions performed by the user, such as nodding or shaking of the head) and/or voice data (e.g., a recording of the recitation of a certain phrase). The system then stores that information. When the user attempts to prove “liveness,” the system may prompt the user to perform similar visual and/or voice actions. The system then determines whether the performed actions correspond to the stored information to determine the liveness of the user.

However, with the improvement of computer technology, there are many tools available that can be used to synthesize video information or voice content used for such liveness detection based on pre-acquired visual and/or voice information of the user. As a result, the user information may simply be “spoofed” or counterfeited by a malicious user by using these tools. Such spoofing can compromise the safeguard provided by the liveness detection and hence, adds vulnerability to the authentication process.

To solve this problem, embodiments described herein enhance the efficiency of the liveness detection system by incorporating uncertainty into the audio and/or visual inputs obtained for liveness detection. During operation, upon determining that a user is authenticating himself/herself to gain access to a service, the system can initiate a liveness detection process. To do so, the system can provide a specialized user interface that displays verification content to the user in such a way that the user should be uncertain of the verification content. In some embodiments, the verification content can include phrases for the user to read in accordance with specific reading instructions for each of the phrases. A phrase can include one or more of: a meaningful phrase, a set of related or unrelated words, one or more characters, one or more numbers (e.g., one or more digits), one or more symbols (e.g., an up arrow, a square, a circle, etc.), and one or more patterns (e.g., polka dot or checkered). Since the user may not be aware of what to read and in which style to read, what verification content would appear on the user interface is uncertain to the user.

The reading style may specify the manner in which the user should read a certain phrase. For example, the reading style can specify the length, intensity, pitch, volume, etc., for each of the phrases or one or more words/characters in a phrase. Prior to obtaining user's voice signal, the system may recite a respective phrase to provide the user a guideline regarding how the user should read the phrase. The system then captures the phrases recited by the user using a voice input device, such as a microphone. In other words, the system obtains the voice signal generated by the user by reading the phrases. The system analyzes the voice signal to verify whether the user has read the correct content of each phrase in the specified reading style. A successful verification can indicate “liveness” of the user. Since a malicious party (e.g., a bot) may not know which phrase and corresponding reading style would appear in the user interface, only a human may successfully read the correct content of each phrase in the specified reading style, thereby mitigating spoofing in liveness detection.

In some embodiments, to further strengthen the liveness detection process, the system can also use a visual input device (e.g., a camera) to record the user's facial expression (e.g., the user's mouth movement) while reciting the phrases. Since the user's mouth is expected to move in a certain way for a specific reading style, the system can compare the user's mouth movement with the expected mouth movement for the phrase. Based on the comparison, if the recorded and expected mouth movements match by more than a threshold value, the system determines liveness of the user.

Furthermore, the current voice or facial action synthesis application may not be capable of synthesizing voice and/or video that represents the textual content and the corresponding phonetic pronunciation of the characters in the phrases. Hence, the system's use of both uncertain phrases and reading style may prevent malicious parties (e.g., a hacker or an attacker) from using synthesized voice and/or video signals to spoof liveness. In this way, the difficulty of spoofing the liveness detection system is significantly increased and hence, the authentication service associated with the liveness detection is greatly enhanced.

### Exemplary System

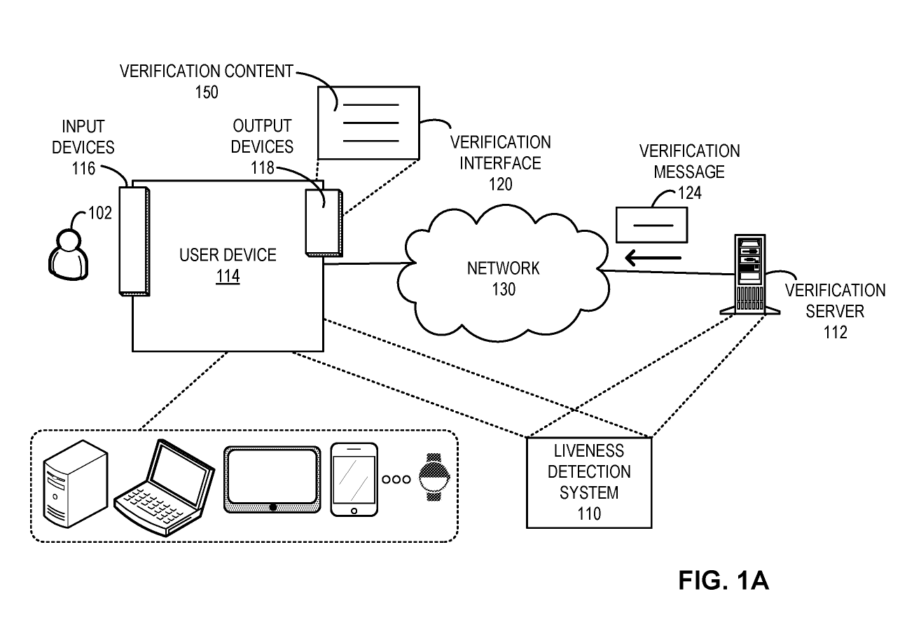

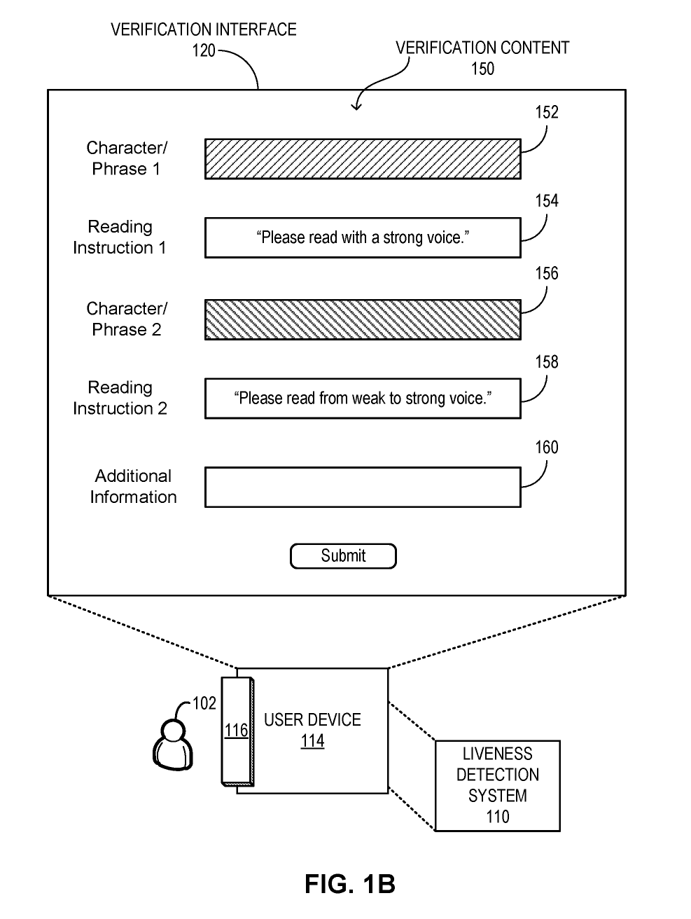

FIG. 1A illustrates an exemplary uncertainty-based liveness detection system, in accordance with an embodiment of the present application. In this example, a user 102 can use a user device 114 to access one or more services. Examples of user device 114 can include, but are not limited to, a desktop, a laptop, a tablet, a smartphone, and a wearable device (e.g., a smartwatch). User device 114 can be equipped with one or more input devices 116. Input devices 116 can include, but are not limited to, a camera, a microphone, a touch interface, a keyboard, a pointing device, and a gesture detection device. User device 114 can also be equipped with one or more output devices 118. Output devices 118 can include, but are not limited to, a display device (e.g., a display monitor), a speaker, a pair of headphones, and one or more indicator lights.

User device 114 can include a liveness detection system 110, which can use input devices 116 to facilitate liveness detection by determining whether user 102 is complying with certain instructions. For example, system 110 may provide instructions for one or more actions (e.g., blinking or gesturing) and use input devices 116 to record corresponding user actions performed by user 102. System 110 then determines whether user 102 has performed the corresponding actions and establishes that user 102 is a real human in response to user 102 performing the actions correctly.

With existing technologies, user 102 may attempt to authenticate to gain access to a service. System 110 may use facial recognition, voiceprint recognition, or both to determine whether a human is performing the authentication. Typically, system 110 can pre-acquire visual data (e.g., a video of certain actions performed by user 102, such as nodding or shaking of the head) and/or voice data (e.g., a recording of a certain phrase recited by user 102). System 110 then stores the audio and/or visual information in a local storage device. When user 102 attempts to prove “liveness,” system 110 may prompt user 102 to perform similar visual and/or voice actions. System 110 then determines whether the performed actions correspond to the stored information to determine liveness of user 102.

However, with the improvement of computer technology, there are many tools available that can be used to synthesize video information or voice content. Such synthetic audio and/or video information can be applied to input devices 116 instead of a real user. In this way, the user information may simply be “spoofed” or counterfeited by a malicious user if system 110 uses pre-acquired visual and/or voice information of user 102 for liveness detection. Such spoofing can compromise the safeguard provided by system 110, hence adding vulnerability to the authentication process.

To solve this problem, the efficiency of system 110 can be enhanced by incorporating uncertainty into the audio and/or visual inputs obtained by input devices 116 for liveness detection. During operation, upon determining that user 102 is authenticating himself/herself to gain access to a service, system 110 can initiate a liveness detection process. To do so, system 110 can provide a specialized user interface, which is referred to as a verification interface 120, that displays verification content 150 to user 102. Verification interface 120 can be displayed on the display device of output devices 118. In some embodiments, the display device can also operate as one of input devices 116 (e.g., a touchscreen device).

System 110 generates verification content 150 in such a way that user 102 should be uncertain of verification content 150. Verification content 150 can include one or more phrases for user 102 to read in accordance with specific reading instructions for each of the phrases. Since user 102 may not be aware of what to read and in which style to read, verification content 150 would appear uncertain to user 102. Therefore, a malicious party may not be able to synthesize the audio information to spoof verification content 150.

In some embodiments, system 110 can operate on a distributed architecture and the enhancement of the liveness detection is derived from the distributed architecture. System 110 can then run on a verification server 112 as well as user device 114. Verification server 112 can communicate with user device 114 via a network 130, which can be a local area network (LAN) or a wide area network (WAN) (e.g., the Internet). The instance of system 110 that runs on verification server 112 can be responsible for generating verification content 150, including it in a verification message 124 (e.g., a network packet based on the Internet Protocol (IP)), and sending the verification message 124 to user device 114.

In this way, even if user device 114 is compromised (e.g., malware), verification content 150 can still be uncertain to user 102. The instance of system 110 that runs on user device 114 can be responsible for displaying verification content 150 in verification interface 120 to user 102 and recording user actions using input devices 116. This instance of system 110 can detect liveness for user 102 locally. Verification message 124 then can further include the expected user actions for verification content 150 that can be used as benchmark for detecting liveness. The recorded information can also be sent to verification server 112. The instance of system 110 that runs on verification server 112 can then detect the liveness of user 102 based on the recoded information and the expected user actions for verification content 150.

FIG. 1B illustrates an exemplary verification interface that facilitates uncertainty-based liveness detection, in accordance with an embodiment of the present application. To initiate the liveness detection process, system 110 displays verification interface 120 on a display device of user device 114. Verification interface 120 displays verification content 150, which can include one or more phrases 152 and 156, to user 102. Each of phrases 152 and 156 can include one or more of: a meaningful phrase, a set of related or unrelated words, one or more characters, one or more numbers (e.g., one or more digits), and one or more symbols (e.g., an up arrow, a square, a circle, etc.).

System 110 can maintain a number of phrases (e.g., a large pool of electronic books), or randomly obtain phrases from online resources (e.g., from newspaper articles available via the Internet) from which system 110 can select phrases 152 and 156. It should be noted that system 110 may generate a phrase by scrambling different characters, words, numbers, and symbols. System 110 can also obtain a meaningful phrase, scramble the words of that phrase, and present both the meaningful and scrambled phrases in verification interface 120. System 110 can randomly determine (e.g., based on generating a random integer within a predetermined range) how many phrases to display on verification interface 120.

Verification content 150 can also include reading instructions, which specify the manner or styles 154 and 158 in which the user should read phrases 152 and 156, respectively. For example, reading styles 154 and 158 can specify the length, intensity, pitch, volume, etc., for phrases 152 and 156, respectively. Reading styles 154 and 158 can further specify the reading style for a part of a phrase (e.g., one or more characters) as well. Examples of reading styles include, but are not limited to, “long,” “short,” “strong,” “weak,” “high,” “low,” “from strong to weak,” “from weak to strong,” “long interval,” “short interval,” etc.

In some embodiments, verification interface 120 can also allow user 102 to enter additional information 160 (e.g., a text box). Examples of additional information include, but are not limited to, a captcha, a verification code, and a verification checkbox. System 110 may recite phrases 152 and 154 before capturing the voice signal to provide the user a guideline regarding how the user should read the phrase. System 110 can then obtain the voice signal generated by user 102 from reading phrases 152 and 156 using input devices 116. System 110 analyzes the voice signal to verify whether user 102 has read the correct content of phrase 152 in reading style 154, and the correct content of phrase 156 in reading style 158. If system 110 determines that user 102 has read phrases 152 and 156 in the corresponding reading style, system 110 determines the “liveness” of user 102. Since a malicious party (e.g., a bot) may not know the contents of phrases 152 and 156, and corresponding reading styles 154 and 158, only a human may successfully read the correct content of phrases 152 and 156 in reading styles 154 and 158, respectively. This uncertainty can mitigate the chances of spoofing for system 110.

### Liveness Detection

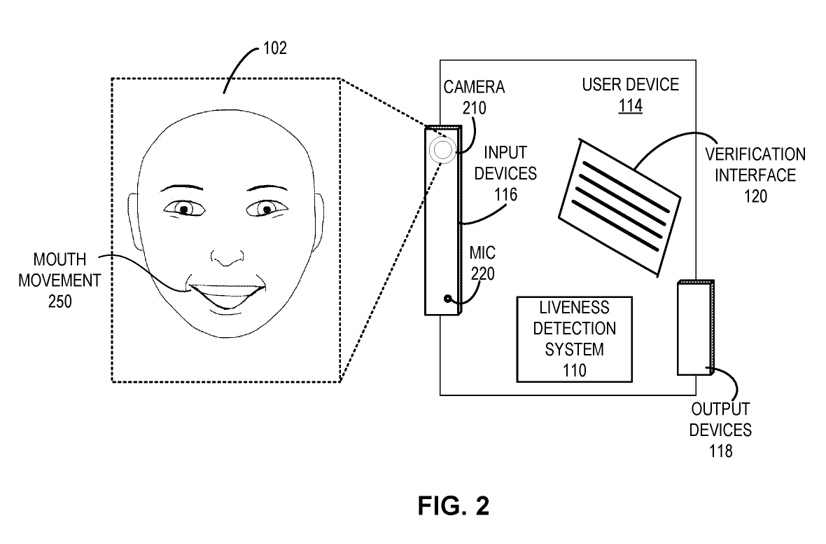

FIG. 2 illustrates an exemplary mouth action detection of a liveness detection system, in accordance with an embodiment of the present application. User device 114 can be equipped with a camera 210 and a microphone 220 to capture visual and audio signals, respectively, from user 102. To establish liveness, user 102 reads the phrases presented in verification interface 120. System 110 can capture the voice signal produced by user 102 using microphone 220. To ensure that user 102 recites the phrases in a proper way, system 110 may recite the phrases in verification interface 120 prior to obtaining user 102's recitation. This allows system 110 to provide user 102 a guideline regarding how user 102 should read the phrases in verification interface 120.

To further strengthen the liveness detection process, system 110 can also use camera 210 to record the facial expressions of user 102. Such facial expression can include user 102's mouth movements while reciting the phrases in verification interface 120. Since user 102's mouth is expected to move in a certain way for a specific phrase in a reading style, system 110 can compare user 102's mouth movement 250 with the expected mouth movement for the phrase. Based on the comparison, if the recorded and expected mouth movements match more than a threshold value, system 110 determines liveness of user 102.

Furthermore, the current voice or facial action synthesis application may not be capable of synthesizing voice and/or video that represents the textual content and the corresponding phonetic pronunciation of the characters in the phrases in verification content 150. Hence, system 110's use of both uncertain phrases and reading style may prevent malicious parties from using synthesized voice and/or video signals to spoof liveness. In this way, the difficulty of spoofing system 110 is significantly increased and hence, the authentication service associated with the liveness detection is greatly enhanced.

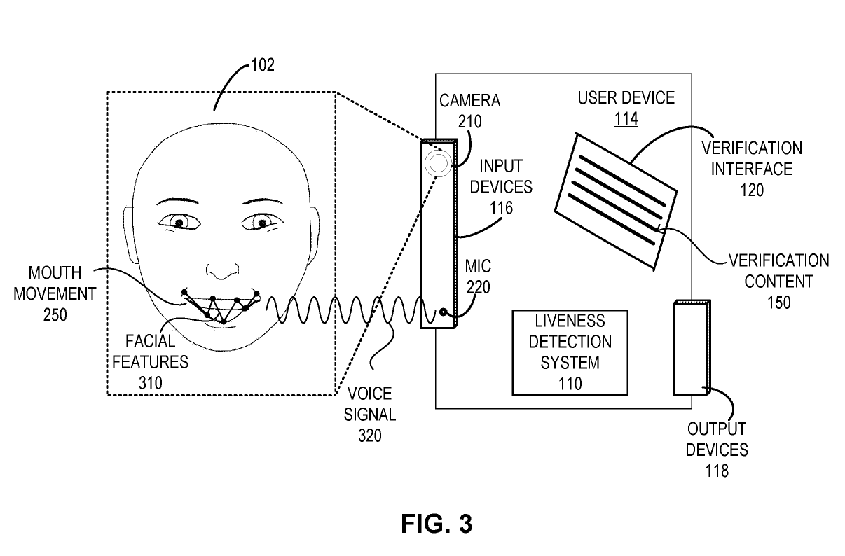

FIG. 3 illustrates an exemplary liveness detection system using audio-visual uncertainty, in accordance with an embodiment of the present application. During operation, system 110 prompts verification content 150 to user 102. The phrases in verification content 150 can include one or more sub-phrases, each of which can include one or more of: a character, a word, a number, and a pattern or a symbol. These sub-phrases can be randomly selected from a candidate set, or based on a predetermined design solution. The reading styles, which are specified by the corresponding reading instructions in verification content 150, can indicate duration of pronunciation, a length, an intensity, and a pitch of a respective sub-phrase. The reading style can also indicate a variation of the intensity during the pronunciation and an interval of pronunciation of adjacent characters or sub-phrases. The reading styles can be randomly selected from a candidate set of reading styles, or based on a predetermined design solution.

A respective reading instruction can correspond to a sub-phrase and include a reading style for that sub-phrase. Such reading style can include one or more of: “long,” “short,” “strong,” “weak,” “high,” “low,” “from strong to weak,” “from weak to strong,” “long interval,” “short interval,” etc. System 110 can also incorporate patterns and symbols into verification interface 120. To provide a guideline how a sub-phrase should be read, system 110 can generate a read-out (or recitation) of the sub-phrase in the corresponding reading style and provide the read-out to user 102 via the speakers or headphones of output devices 118. System 110 can introduce some noise into the read-out to detect any recording of the read-out being played back to system 110.

In some embodiments, system 110 can use additional display features to indicate the reading styles of a sub-phrase. Such display features can include, but are not limited to, appearance, position, dimension, color, and font of the sub-phrase. For example, if the font of a sub-phrase is large, user 102 is expected to read that sub-phrase loudly. Similarly, if the color of a sub-phrase is red, user 102 is expected to read that sub-phrase with a high pitch. Verification interface 120 can specify what appearance, position, dimension, color, and/or font of a sub-phrase indicate. System 110 can include such information in the reading instructions. System 110 can also reshuffle the expected user action corresponding to the appearance, position, dimension, color, and/or font of a sub-phrase. For example, in one instance, a large font can indicate a loud reading, and in another instance, a large font can indicate a high-pitched reading. Since this reshuffling is also uncertain to user 102, the reshuffling can add an additional layer of liveness detection.

System 110 can include a text and/or a read-out of an explicit instruction for user 102 to initiate the liveness detection. User 102 can then start reading the phrases of verification content 150. System 110 can record user 102's voice signal 320 using microphone 220. System 110 then verifies whether user 102 has correctly recited the phrases of verification content 150. System 110 also checks whether user 102 has recited the phrase in the specified reading style. Suppose that verification content 150 includes a phrase “a quick brown fox” with sub-phrases “a quick” and “brown fox,” and a corresponding reading style that indicates that user 102 should read “a quick” in a loud voice and “brown fox” in a high-pitched voice. System 110 can check whether user 102 has recited each of the sub-phrases correctly and in the corresponding reading style.

To determine whether user 102 has correctly recited the phrases of verification content 150, system 110 can use a voice recognition technique (e.g., a speech to text converter) to determine the text from voice signal 320. System 110 then can compare the text with the phrases to determine whether they match. Depending on the configuration of system 110, if system 110 detects a mismatch, system 110 may or may not proceed to the verification of the reading style. An administrator of system 110 can configure whether system 110 should continue with the verification of the reading style even after detecting a mismatch. In some embodiments, system 110 may proceed with the verification of the reading style if user 102 has correctly recited more than a threshold number of characters.

In the step of identifying the reading styles, system 110 analyzes voice signal 320 to identify the pronunciation of each of the sub-phrases of verification content 150. To identify the pronunciation of a sub-phrase, system 110 determines one or more of: time analysis, length analysis, pitch analysis, intensity analysis, and variation analysis. The time analysis can include determining the relative time of appearance of the sub-phrase in voice signal 320. The length sequencing can include determining the relative length of the sub-phrase compared to the corresponding phrase and/or other phrases (e.g., the length type, such as long or short, a position of the sub-phrase in the phrase, etc.).

Furthermore, the intensity analysis can include determining the intensity of the sub-phrase (e.g., whether the intensity type is strong, weak, or at a certain level of intensity). The pitch analysis can include determining the pitch of the sub-group (e.g., whether the pitch type is high, low, or at a certain pitch). Moreover, variation analysis can include determining whether voice signal 320 incorporates the variation specified by a corresponding reading style (e.g., changes from strong to weak or weak to strong), and the length of the interval between the sub-phrase and its adjacent sub-phrase(s). In each of the analyses, system 110 can use a ranking of the sub-phrase among the sub-phrases based on the corresponding feature (e.g., the length, intensity, and/or pitch) of the sub-phrase.

Based on these determinations, system 110 determines whether the reading style of user 102 is consistent with the reading style prompted by verification content 150. In some embodiments, system 110 calculates the ratio of user 102's recitation of the sub-phrases in voice signal 320 that are consistent with the corresponding reading style and all sub-phrases (and corresponding reading styles) in verification content 150. If the ratio is greater than a predetermined threshold, system 110 considers that user 102's recitations are consistent with the specified reading style. Otherwise, system 110 determines that user 102's recitations are inconsistent.

To further strengthen the liveness detection process, system 110 can also use camera 210 to record the facial features 310 of user 102 to determine mouth movement 250 while reciting the phrases in verification content 150. System 110 can use camera 210 to capture a video of mouth movement 250 and an automatic facial recognition (e.g., by using a dedicated algorithm) to determine whether mouth movement 250 and the corresponding shape variations comply with each of the sub-phrases of verification content 150. Since user 102's mouth is expected to move in a certain way for a specific sub-phrase in a corresponding reading style, system 110 can compare user 102's mouth movement 250 with the expected mouth movement for the phrase. Based on the comparison, if the recorded and expected mouth movements match by more than a threshold value, system 110 determines that user 102's recitations are consistent with the specified reading style.

If system 110 determines that user 102 has recited (i) the correct sub-phrases, (ii) in the specified reading styles, and (ii) with compliant mouth movements, system 110 determines that user 102 has successfully established liveness. It should be noted that system 110 can establish liveness of user 102 based on one or more of the above criteria. In other words, system 110 may check a subset of the above criteria to establish liveness. For example, system 110 can determine liveness of user 102 based on only the compliance with the reading style, or can also check the correctness of the recitation. On the other hand, if system 110 determines that user 102's recitation does not meet the set of criteria, system 110 determines that user 102 has failed to establish liveness.

To determine the reading style from voice signal 320, system 110 can pre-process voice signal 320 to eliminate the background noise in voice signal 320. To do so, system 110 can use one or more of: an independent component analysis, an adaptive filter, and a wavelet transformation. System 110 can also remove any gap segment (e.g., a gap in user 102's recitation) from voice signal 320. System 110 can identify the low energy level in voice signal 320 to identify a gap segment. System 110 then can divide voice signal 320 into one or more voice segments. System 110 can use an in-frame feature similarity of voice signal 320 for the segmentation. Specifically, system 110 can divide voice signal 320 into voice segments based on a predetermined length.

In some embodiments, system 110 can extract a mel-frequency cepstral coefficients (MFCC) with linear prediction coefficient (LPC) (MFCC-LPC) with respect to the signal frame in each voice segment. System 110 can use a sum of respective feature vector distances between all signal frames in each voice segment and all the signal frames in the adjacent voice segments as the metric of the difference of vector voice segments. During the recitation, when user 102 transitions from one sub-phrase to another, the segment spacing is typically increased. Therefore, system 110 can determine the segmentation position based on the magnitude of the segment spacing.

System 110 then calculates the feature related to the attribute to be identified for each sub-phrase. For example, with respect to the relative duration of the pronunciation of a sub-phrase, the feature is a difference between the start time of the voice signal corresponding to the sub-phrase and the start time of the voice signal of the first sub-phrase of verification content 150. Similarly, with respect to the length and interval length associated with a sub-phrase, the feature can be the duration of the voice signal of the sub-phrase. With respect to the pronunciation intensity of a sub-phrase, the feature can be a short-term energy or a short-term average magnitude value of the sub-phrase. With respect to the pitch of the sub-phrase, the feature can be a base frequency. With respect to the variation of the pronunciation intensity between sub-phrases, the feature can be a difference between a first half short-term energy and a second half short-term energy or between a first half short-term average magnitude value and a second half short-term average magnitude value.

System 110 then categorizes the features of each sub-phrase. For example, with respect to the pronunciation time and intensity variation, system 110 may compare the feature with the predetermined threshold to determine whether the pronunciation complies with the expected style of pronunciation indicated in the corresponding reading style. With respect to the length, the interval length, the intensity, and the pitch, system 110 may determine a ranking (e.g., a sequence of the feature) of the corresponding features of all sub-phrases and categorize these features based on the ranking.

### Operations

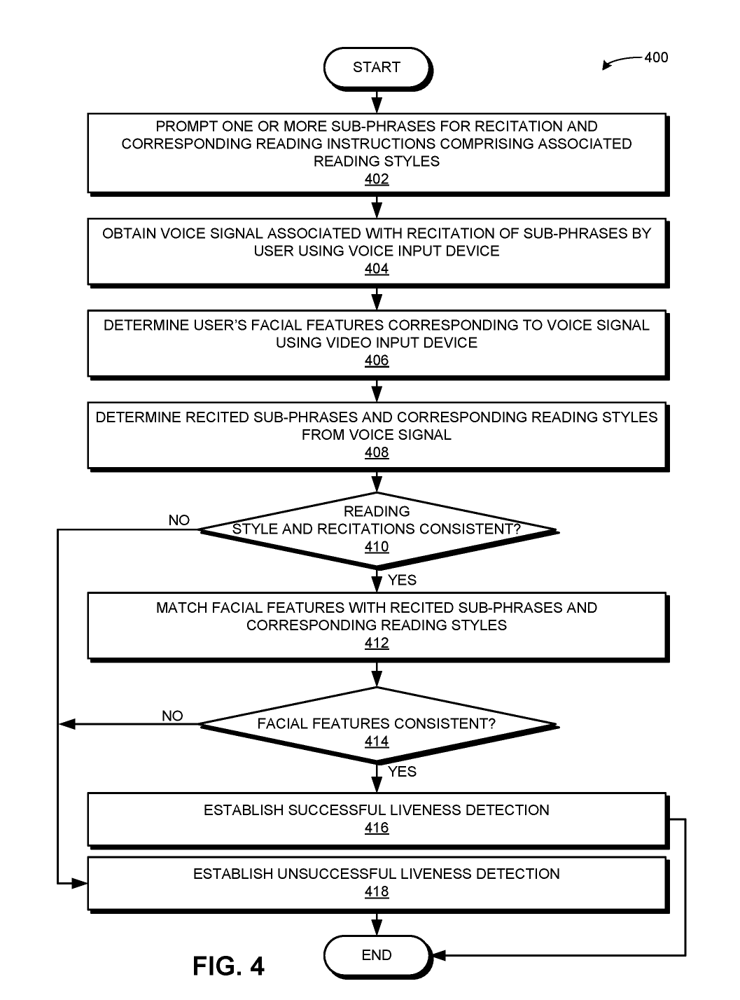

FIG. 4 presents a flowchart 400 illustrating a method of a liveness detection system determining liveness of an authenticating user, in accordance with an embodiment of the present application. During operation, the system prompts one or more sub-phrases for recitation and the corresponding reading instructions comprising associated reading styles (operation 402). The system can also provide a read-out of the sub-phrases in corresponding reading styles to provide a user a guideline. The system then obtains a voice signal associated with the recitation of the sub-phrases by the user using a voice input device (e.g., a microphone) (operation 404). In some embodiments, the system can also determine the user's facial features, such as mouth movements, corresponding to the voice signal using a video input device (e.g., a camera) (operation 406).

The system can determine the recited sub-phrases and the corresponding reading styles from the voice signal (operation 408). The system then checks whether the recited sub-phrases and the corresponding reading styles are consistent with the prompted sub-phrases and reading styles (operation 410). If consistent, the system can match the facial features with the recited sub-phrases and the corresponding reading styles (operation 412). The system checks whether the facial features are consistent (operation 414). If the facial features are consistent as well the recited sub-phrases and the corresponding reading styles, the system establishes a successful liveness detection (operation 416). If the recited sub-phrases and the corresponding reading styles (operation 410) and/or the facial features (operation 414) are inconsistent, the system establishes an unsuccessful liveness detection (operation 418).

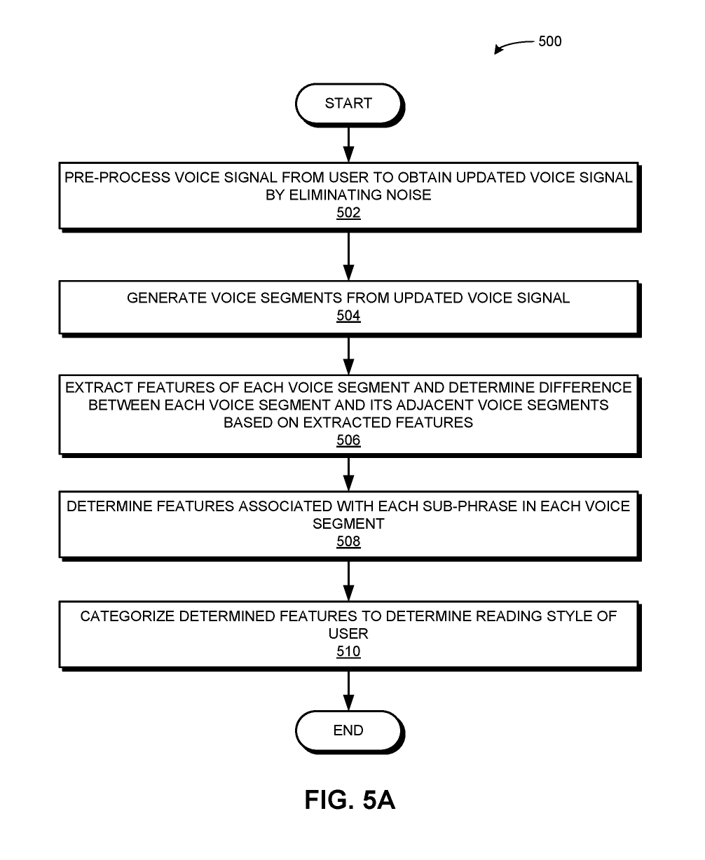

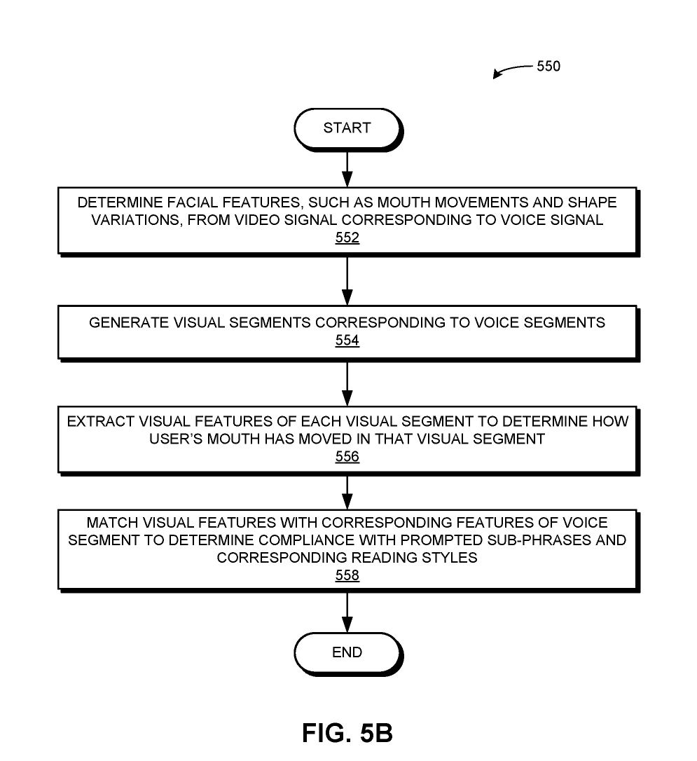

FIG. 5A presents a flowchart 500 illustrating a method of a liveness detection system determining a reading style for liveness detection, in accordance with an embodiment of the present application. During operation, the system pre-processes the voice signal from a user to obtain an updated voice signal by eliminating noise (operation 502). The system generates one or more voice segments from the updated voice signal (operation 504). The system then extracts features of each voice segment and determines the difference between each voice segment and its adjacent voice segments based on the extracted features (operation 506). The system determines the features associated with each sub-phrase in each voice segment (operation 508) and categorizes the determined features to determine the reading style of the user (operation 510).

FIG. 5B presents a flowchart 550 illustrating a method of a liveness detection system determining facial features corresponding to a voice signal for liveness detection, in accordance with an embodiment of the present application. During operation, the system determines the facial features, such as mouth movements and shape variations, from a video signal corresponding to the voice signal (operation 552) and generates visual segments corresponding to voice segments (operation 554). The system then extracts visual features of the user of each video segment to determine how the user's mouth has moved in that visual segment (operation 556). The system matches the visual features with the corresponding features of the voice segment to determine the compliance with the prompted sub-phrases and corresponding reading styles (operation 558).

### Exemplary Computer System and Apparatus

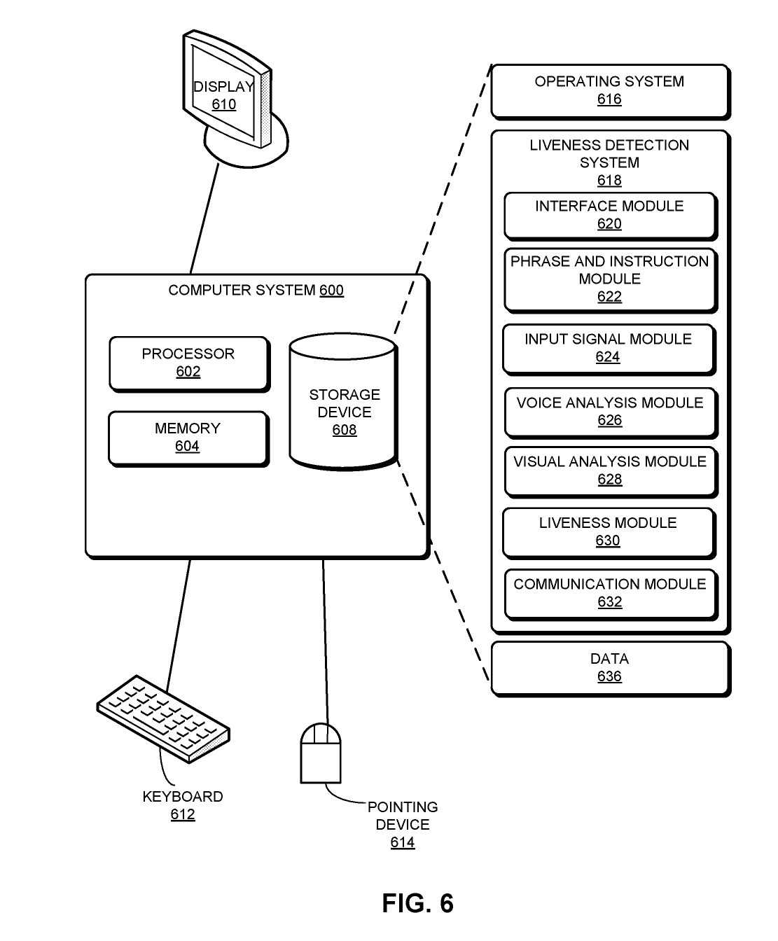

FIG. 6 illustrates an exemplary computer system that facilitates an uncertainty-based liveness detection system, in accordance with an embodiment of the present application. Computer system 600 includes a processor 602, a memory 604, and a storage device 608. Computer system 600 can be coupled to a display device 610, a keyboard 612, and a pointing device 614. Storage device 608 can store an operating system 616, a liveness detection system 618, and data 636.

Liveness detection system 618 can include instructions, which when executed by computer system 600, can cause computer system 600 to perform methods and/or processes described in this disclosure. Specifically, liveness detection system 618 can include instructions for presenting a verification interface to a user (interface module 620). Liveness detection system 618 can also include instructions for determining a set of sub-phrases and corresponding reading styles that are prompted in the verification interface (phrase and instruction module 622). Furthermore, liveness detection system 618 can include instructions for facilitating a read-out of the set of sub-phrases in the corresponding reading styles (phrase and instruction module 622).

Furthermore, liveness detection system 618 includes instructions for obtaining voice and/or video signals from the user (input signal module 624). Liveness detection system 618 can also include instructions for analyzing the voice signal to determine the user's recitation and reading styles for each of the sub-phrases (voice analysis module 626). Liveness detection system 618 can also include instructions for analyzing the video signal to determine the user's facial features during the user's recitation of each of the sub-phrases (video analysis module 628). Liveness detection system 618 can further include instructions for establishing liveness for the user based on the analyses (liveness module 630). Liveness detection system 618 can also include instructions for sending and receiving packets (communication module 632).

Data 636 can include any data that is required as input or that is generated as output by the methods and/or processes described in this disclosure. Specifically, data 636 can store at least: a repository of sub-phrases from which liveness detection system 618 selects the sub-phrases, a set of possible reading styles, the recorded voice and/or video signals, voice and/or video segments, and analytical information associated with the voice and/or video signals.

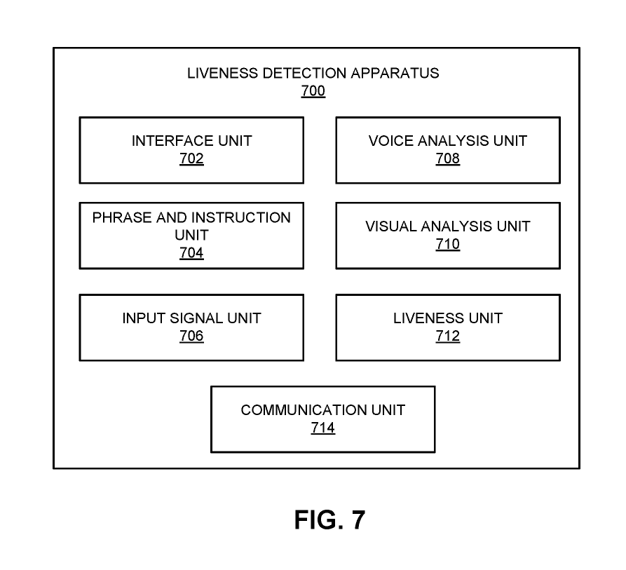

FIG. 7 illustrates an exemplary apparatus that facilitates an uncertainty-based liveness detection system, in accordance with an embodiment of the present application. Apparatus 700 can comprise a plurality of units or apparatuses which may communicate with one another via a wired, wireless, quantum light, or electrical communication channel. Apparatus 700 may be realized using one or more integrated circuits, and may include fewer or more units or apparatuses than those shown in FIG. 7. Further, apparatus 700 may be integrated in a computer system, or realized as a separate device which is capable of communicating with other computer systems and/or devices. Specifically, apparatus 700 can comprise units 702-714, which perform functions or operations similar to modules 620-632 of computer system 600 of FIG. 6, including: an interface unit 702, a phrase and instruction unit 704, an input signal unit 706, a voice analysis unit 708, a visual analysis unit 710, a liveness unit 712, and a communication unit 714.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing embodiments described herein have been presented for purposes of illustration and description only. They are not intended to be exhaustive or to limit the embodiments described herein to the forms disclosed. Accordingly, many modifications and variations will be apparent to practitioners skilled in the art. Additionally, the above disclosure is not intended to limit the embodiments described herein. The scope of the embodiments described herein is defined by the appended claims.

What is claimed is:

1. A computer-implemented method for facilitating liveness detection of a user, the method comprising:
presenting, by a computing device, a verification interface to the user in a local display device, wherein the verification interface includes one or more phrases and a reading style for a respective phrase in which the user is expected to recite the phrase;
obtaining a voice signal based on the user's recitation of the one or more phrases via a voice input device of the computing device;
determining whether the user's recitation of a respective phrase has complied with the corresponding reading style; and
in response to determining that the user's recitation of a respective phrase has complied with the corresponding reading style, establishing liveness for the user.

2. The method of claim 1, further comprising providing a read-out of a respective phrase of the one or more phrases in a corresponding reading style as a guideline to the user.

3. The method of claim 1, further comprising:
determining whether the user has recited a respective phrase correctly;
wherein establishing liveness for the user is further dependent upon determining that the user has recited a respective phrase correctly.

4. The method of claim 1, further comprising:
obtaining a video signal corresponding to the voice signal via a voice input device of the computing device;
determining mouth movements of the user from the video signal; and
determining whether the mouth movements are consistent with the user's recitation of a respective phrase in the corresponding reading style;
wherein establishing liveness for the user is further dependent upon determining that the mouth movements are consistent.

5. The method of claim 1, wherein determining whether the user's recitation of a respective phrase has complied with the corresponding reading style includes:
pre-processing the voice signal to eliminate noise; and
generating one or more voice segments from the voice signal.

6. The method of claim 5, further comprising:
extracting features from a respective voice segment;
determining features associated with a respective phrase of a respective voice segment; and
categorizing the determined features.

7. The method of claim 1, wherein the reading style for a respective phrase is indicated based on one or more display features, wherein the display features include one or more of: appearance, position, dimension, color, and font of the phrase.

8. The method of claim 7, further comprising:
displaying the one or more phrases in the verification interface in accordance with the display features; and
specifying what the display features indicate.

9. The method of claim 1, further comprising determining the one or more phrases prior to presenting the verification interface to the user, wherein determining the one or more phrases includes one or more of:
obtaining a phrase from a repository of phrases;
obtaining a phrase from the Internet; and
reshuffling words and/or characters of a phrase.

10. The method of claim 1, wherein a respective phrase of the one or more phrases includes one or more of: a meaningful phrase, a set of related or unrelated words, one or more characters, one or more numbers, one or more symbols, and one or more patterns.

11. A non-transitory computer-readable storage medium storing instructions that when executed by a computer cause the computer to perform a method for facilitating liveness detection of a user, the method comprising:
presenting a verification interface to the user in a local display device, wherein the verification interface includes one or more phrases and a reading style for a respective phrase in which the user is expected to recite the phrase;
obtaining a voice signal based on the user's recitation of the one or more phrases via a voice input device of the computer;
determining whether the user's recitation of a respective phrase has complied with the corresponding reading style; and
in response to determining that the user's recitation of a respective phrase has complied with the corresponding reading style, establishing liveness for the user.

12. The non-transitory computer-readable storage medium of claim 11, wherein the method further comprises providing a read-out of a respective phrase of the one or more phrases in a corresponding reading style as a guideline to the user.

13. The non-transitory computer-readable storage medium of claim 11, wherein the method further comprises:
determining whether the user has recited a respective phrase correctly;
wherein establishing liveness for the user is further dependent upon determining that the user has recited a respective phrase correctly.

14. The non-transitory computer-readable storage medium of claim 11, wherein the method further comprises:
obtaining a video signal corresponding to the voice signal via a voice input device of the computer;
determining mouth movements of the user from the video signal; and
determining whether the mouth movements are consistent with the user's recitation of a respective phrase in the corresponding reading style;
wherein establishing liveness for the user is further dependent upon determining that the mouth movements are consistent.

15. The non-transitory computer-readable storage medium of claim 11, wherein determining whether the user's recitation of a respective phrase has complied with the corresponding reading style includes:
pre-processing the voice signal to eliminate noise; and
generating one or more voice segments from the voice signal.

16. The non-transitory computer-readable storage medium of claim 15, wherein the method further comprises:
extracting features from a respective voice segment;
determining features associated with a respective phrase of a respective voice segment; and
categorizing the determined features.

17. The non-transitory computer-readable storage medium of claim 11, wherein the reading style for a respective phrase is indicated based on one or more display features, wherein the display features include one or more of: appearance, position, dimension, color, and font of the phrase.

18. The non-transitory computer-readable storage medium of claim 17, wherein the method further comprises:
displaying the one or more phrases in the verification interface in accordance with the display features; and
specifying what the display features indicate.

19. The non-transitory computer-readable storage medium of claim 11, wherein the method further comprises determining the one or more phrases prior to presenting the verification interface to the user, wherein determining the one or more phrases includes one or more of:
obtaining a phrase from a repository of phrases;
obtaining a phrase from the Internet; and
reshuffling words and/or characters of a phrase.

20. The non-transitory computer-readable storage medium of claim 11, wherein a respective phrase of the one or more phrases includes one or more of: a meaningful phrase, a set of related or unrelated words, one or more characters, one or more numbers, one or more symbols, and one or more patterns.
